(19) United States
(12) Patent Application Publication
(10) Pub. No.: US 2015/0099100 A1
(43) Pub. Date: Apr. 9, 2015

(54) NOVEL PROCESSES FOR APPLYING MATERIALS HAVING A SPECIFIC PATTERN ONTO A SUBSTRATE SURFACE

(71) Applicants: ADAM HUNT, GREENFIELD, IN (US); THOMAS LEWIS, ZIONSVILLE, PA (US)

(72) Inventors: ADAM HUNT, GREENFIELD, IN (US); THOMAS LEWIS, ZIONSVILLE, PA (US)

(21) Appl. No.: 14/505,823

(22) Filed: Oct. 3, 2014

Related U.S. Application Data
(60) Provisional application No. 61/887,756, filed on Oct. 7, 2013.

(51) Int. Cl. B05D 1/28; B05D 5/08

(52) U.S. Cl. CPC B05D 1/28; B05D 5/08
USPC 428/195.1; 427/256

(57) ABSTRACT

Unique and improved methods of applying materials onto various parts to create a pre-defined pattern with improved thickness and control are disclosed. A controlled amount of material is applied at a selected compound surface to produce a predetermined pattern incrementally built-up at a specific region of a surface. The improved repeatability of the process facilitates higher material utilization, reduced material waste and minimal personnel exposure to the handling of potentially hazardous materials.

### RELATED APPLICATIONS

This application claims priority to U.S. provisional application Ser. No. 61/887,756 filed Oct. 7, 2013, the disclosure of which is incorporated by reference herein in its entirety.

### FIELD OF INVENTION

The present invention relates to novel methods for applying a controlled amount of material to produce a predetermined pattern at a specific region of a substrate surface.

### BACKGROUND OF THE INVENTION

Fretting is a type of metal-to-metal contact wear that is prevalent in many industries and applications. Fretting can occur when metal parts are forced together and a rubbing action occurs between the parts. Frictional heat is generated that can potentially rip and/or tear out portions of metal surfaces. The metal parts eventually seize together as a result of lack of lubrication between the metal parts.

Dry film lubricants (hereinafter, referred to as “DFL's”) have emerged as a means for reducing fretting. The DFL's are a superior alternative to greases and oils where clean adherence to components and frictional reduction are required. DFL's can reduce the tendency for metal or metal alloy components to fret when in sliding or vibrational contact with itself or with other alloy materials. They are effective in preventing seizure of parts which are forced together through a rubbing action.

DFL's have utility in various applications. By way of example, DFL's can be applied to selective regions of numerous parts to lower frictional forces and enhance abrasion resistance. Examples of parts that DFL's can be applied onto include a compressor blade, the engagement portion of a shaft or pin into a receiver pocket or a sliding face of a slat track. Generally speaking, the DFL's are applied only onto a predefined area of the part with the immediate surrounding area preferably masked so as to not cause inadvertent overspray of the DFL in these areas where DFL material is not permitted.

Currently, DFL's are generally applied manually by brushing, air brushing, spraying or dipping. However, the manual application of such DFL's has numerous drawbacks. For example, the manual application of a DFL or any other type of lubricant or masking agent or other material is severely compromised by the inability to apply DFL's at a controlled thickness to cover only a desired section of a part. The variation in film-covered parts often leads to poor repeatability, which may ultimately translate into material losses, part rework and production losses. Manual application of the DFL's can also lead to prolonged exposure of solvents, thereby creating safety hazards for production personnel.

To overcome the drawbacks of manual application, automated possesses, such as automated spraying, have emerged as an alternative means for applying films onto parts. However, the automated spray processes which are currently utilized in various industries continue to be plagued by many of the problems associated with manual application, including thickness control, quality of the resultant film produced on the part and repeatability. Additionally, poor material flow through the automated spray system is a problem with many of today's automated spray processes.

In view of the problems associated with conventional processes for applying dry film lubricants, there is an unmet need for an improved process for applying DFL's that can be selectively applied at a controlled thickness and shape onto selected regions of a substrate. Other advantages and applications of the present invention will become apparent to one of ordinary skill in the art.

### SUMMARY OF THE INVENTION

The invention may include any of the following aspects in various combinations and may also include any other aspect of the present invention described below in the written description.

In a first aspect, a method for producing a predefined pattern onto a substrate surface is provided. A non-porous membrane comprising a distal tip is provided. A plate having a trough is provided, whereby said trough is filled with a selected material and inscribed with the predefined pattern therewithin. The non-porous membrane is lowered towards the plate at a location so as to avoid the distal tip from being immersed in the trough. A selected surface of the non-porous membrane is engaged with the material. The material is transferred from the reservoir onto the surface of the membrane, such that the material adheres to the membrane in a manner that conforms to the predefined pattern contained within said trough. The selected surface of the non-porous membrane is engaged with the substrate. Material from the membrane is transferred to the substrate at a selected location along the substrate. The membrane is lifted away from the substrate, thereby producing the pattern on the substrate.

In a second aspect, a method for producing a predefined pattern onto a substrate surface is provided. A non-porous membrane comprising a distal tip is provided. A plate having a trough is provided, whereby said trough filled with a dry film lubricant (DFL). The trough is inscribed with the predefined pattern therewithin. The non-porous membrane is lowered towards the plate at a location so as to avoid the distal tip from being immersed in the trough. A selected surface of the non-porous membrane is engaged with the DFL. The DFL material is transferred from the reservoir onto the surface of the membrane. The DFL adheres to the membrane in a manner that conforms to the predefined pattern contained within said trough. The selected surface of the non-porous membrane is engaged with the substrate, thereby enabling DFL to be transferred from the membrane to the substrate at a selected location along the substrate. Upon lifting the membrane away from the substrate, the pattern on the substrate is produced. The pattern is produced without masking any portion of the substrate.

Advantageously, the present invention can selectively apply various materials at a controlled thickness and shape to form a pre-defined pattern onto a specific location of a substrate, at a customization level not previously attainable with conventional methods. Production time can be decreased without sacrificing quality, precision and accuracy of the pre-defined pattern.

### BRIEF DESCRIPTION OF THE DRAWINGS

The objectives and advantages of the invention will be better understood from the following detailed description of the preferred embodiments thereof in connection with the accompanying figures wherein like numbers denote same features throughout and wherein:

FIG. 1 shows a DFL material reservoir that is slid along a geometry definition plate (GDP) until positioned directly over a trough extending into the GDP;

FIG. 2 shows the reservoir of FIG. 1 slid along the surface of the GDP until sufficiently positioned away from the trough;

FIG. 3 shows a non-porous membrane being lowered towards the trough of the GDP of FIG. 2 for transfer of the material from the trough to a selected compound surface of the membrane;

FIG. 4 shows the non-porous membrane lifting the material away from the GDP;

FIG. 5 shows the DFL reservoir is moved and returned into position over the trough of FIG. 3 so as to prevent further evaporation or solvent flashing of the DFL material;

FIG. 6 shows the non-porous membrane of FIG. 4 is lowered onto the surface of the substrate;

FIG. 7 shows the membrane of FIG. 5 being raised upwards and away from the substrate;

FIG. 8 shows an exemplary non-porous membrane in accordance with the principles of the present invention;

FIG. 9 shows various cycles of DFL transferred from the GDP to a paper target substrate;

FIG. 10 shows various cycles of DFL transferred from the GDP to a metallic plate substrate; and

FIG. 11 shows an example of a part that can be applied with DFL material to produce a film pattern in accordance with the principles of the present invention.

### DETAILED DESCRIPTION OF THE INVENTION

The objectives and advantages of the invention will be better understood from the following detailed description of the preferred embodiments thereof in connection. The present disclosure relates to novel processes for the application of lubricants and other materials onto a variety of substrates. The methods of the present invention are particularly suitable for the application of materials onto a turbine blade root (i.e., dovetail). The disclosure is set out herein in various embodiments and with reference to various aspects and features of the invention.

The relationship and functioning of the various elements of this invention are better understood by the following detailed description. The detailed description contemplates the features, aspects and embodiments in various permutations and combinations, as being within the scope of the disclosure. The disclosure may therefore be specified as comprising, consisting or consisting essentially of, any of such combinations and permutations of these specific features, aspects, and embodiments, or a selected one or ones thereof.

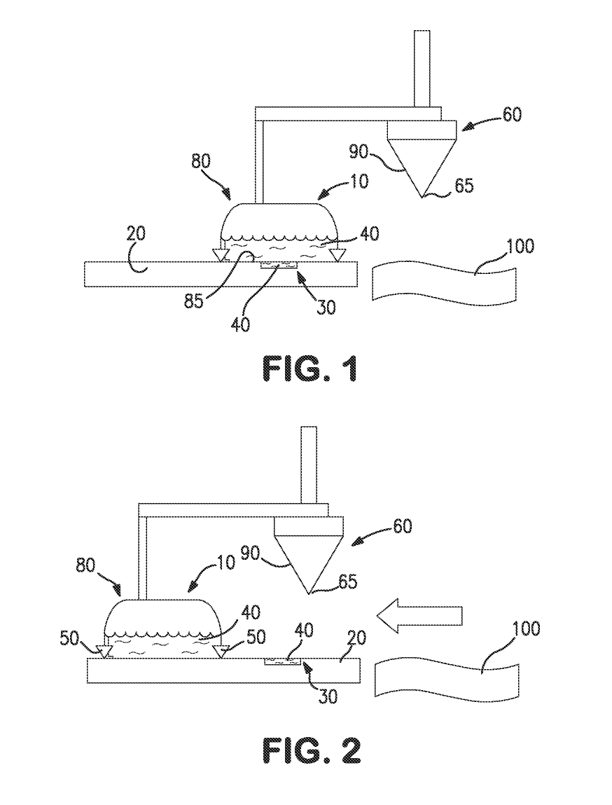

One embodiment of the present invention will now be described in connection with FIGS. 1-7. The Figures show an improved and novel process for applying DFL onto a surface of a substrate. The DFL can be applied at a controlled thickness along a selected surface and region of the substrate surface. As will be described, the accuracy and repeatability of applying the DFL at a controlled thickness and shape eliminates the need to mask those surfaces and regions of the substrate that are not intended to be applied with material.

Referring to FIG. 1, a DFL material reservoir 10 is slid along a geometry definition plate (GDP) 20 until positioned directly over a trough 30 extending into the GDP 20. When the reservoir 10 has been situated over the trough 30, DFL material 40 can be introduced into the reservoir 10. Any suitable means for loading the DFL material 40 into the reservoir 10 can be employed. For example, the reservoir 10 can be inverted as a cup-like structure to expose the opening of the reservoir 10 and thereby allow the material 40 to be introduced therein. Subsequently, the GDP 20 can be clamped in place over the filled reservoir 10. The reservoir-GDP assembly is then re-inverted as a unitary structure to produce the configuration shows in FIG. 1. Alternatively, an auto refill procedure can be utilized by which the DFL material 40 is introduced through a valve assembly that is connected to the top portion 80 of the reservoir 10. In this manner, the reservoir 10 need not be inverted.

The reservoir 10 has an open bottom 85 so that as the DFL 40 enters into the reservoir 10, the DFL material 40 flows and fills into the trough 30 of the GDP 20. The reservoir 10 is entirely enclosed to minimize DFL material 40 from flowing onto surfaces of the GDP 20. Additionally, seals 50 along the periphery of the reservoir 10 confine the DFL 40 within the interior region of the reservoir 10. The trough 30 is filled to a sufficient volume to wet the surfaces of an inscribed and predefined pattern that is contained within the trough 30. The pattern is defined with the desired shape to be applied onto the substrate 100.

Referring to FIG. 2, after the DFL 40 has filled into the trough 30, the reservoir 10 is slid along the surface of the GDP 20 until sufficiently positioned away from the trough 30. The reservoir 10 is moved away from the trough 30 in the direction shown by the arrow in FIG. 2. As the reservoir 10 slides along the surfaces of the GDP 20, its hardened sealed surfaces 50 scrape and wipe away any excess DFL 40 which may have over flown from the trough 30 onto the surfaces of the GDP 20. In this manner, a level volume of DFL material 40 is confined entirely within the interior region of the trough 30.

Having moved the DFL reservoir 10 away from the trough 30, FIG. 2 shows that the DFL material 40 is exposed to the atmosphere for a sufficient time. The exposure allows solvent flash to occur from the surface of the DFL material, thereby forming a viscous surface or tacky layer.

Still referring to FIG. 2, a non-porous membrane 60 with a distal tip 65 is assembled to the top portion 80 of the reservoir 10. As the reservoir 10 is slid away from the trough 30 of the GDP 20, the membrane 60 becomes positioned over the GDP 20. A suitable membrane is selected so as to be compressible yet maintain sufficient hardness to ensure transferability of material to and from a selected compound surface 90 of the membrane 60. The term “compound surface” as used herein is intended to mean a complex surface that can include a combination of simple lines, planes, obliques undulating or blended surfaces or any combinations thereof to compose a continuous or knitted surface profile. The membrane 60 is positioned over the trough 30 at a location such that the distal tip 65 is spaced away from the edges of the trough 30 by a predetermined distance.

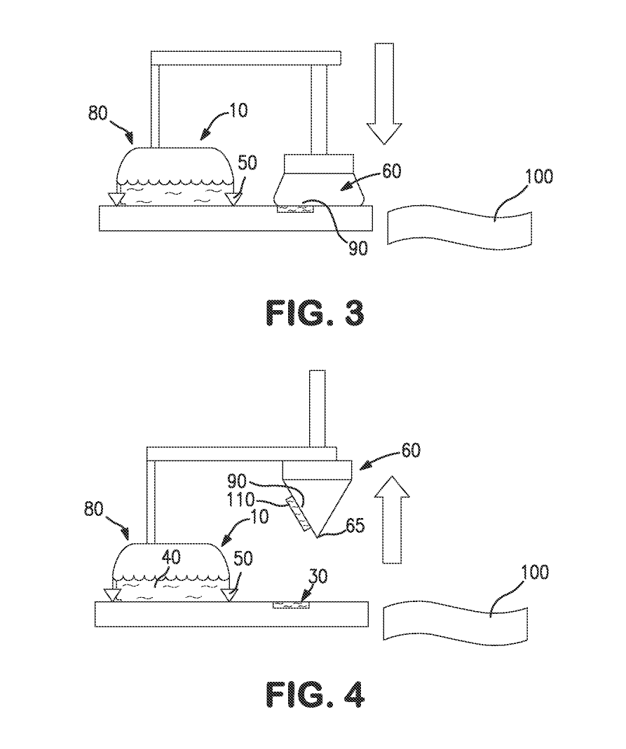

At this selected location, the membrane 60 can engage with the DFL material 40 that is contained in the trough 30. FIG. 3 shows that the membrane 60 is lowered towards the trough 30. The membrane 60 may be lowered, as denoted by the downward arrow, until the distal tip 65 is in close proximity to or abuts the surface of the plate 20. The distal tip 65 does not make contact with the DFL material 40 contained in the trough 30. Only a selected compound surface 90 of the membrane 60 contacts and engages with the viscous surface of the DFL material 40 contained within the trough 30. The membrane 60 compresses and alters its shape to accept the DFL material 40 from the engraved or inscribed area of the trough 30. The increased viscosity of the DFL material 40 at its surface allows a predetermined portion of it to transfer from the reservoir 10 onto the selected compound surface 90 of the membrane 60. The material 40 adheres to the non-porous membrane 60 to conform to the predefined pattern. In this manner, the present invention avoids inadvertent distortion of the pattern created on the compound surface of the membrane 60, thereby ensuring the integrity of the resultant pattern is maintained for each cycle.

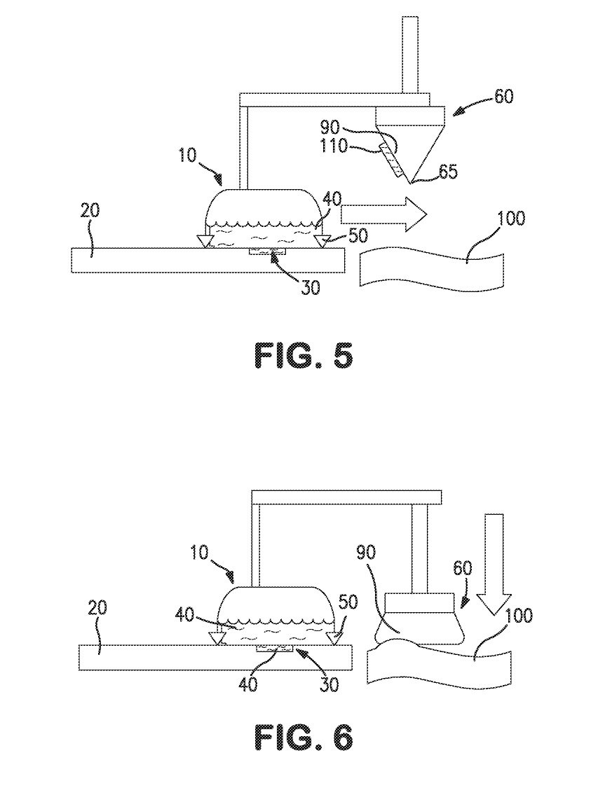

Having transferred the viscous DFL material 40 onto the selected compound surface 90 of the membrane 60, the membrane 60 is raised upwards and away from the trough 30 and plate 20, as indicated by the upward arrow in FIG. 4. With the trough 30 exposed, the DFL reservoir 10 is slid and returned into position over the trough 30 (as indicated by the arrow in FIG. 5) so as to prevent further evaporation or solvent flashing of the DFL material 40, as shown in FIG. 5. Additionally, as the reservoir 10 is positioned over the trough 30 of the GDP 20, the membrane 60 becomes placed above the substrate 100 at a predetermined location. At the predetermined location, FIG. 6 shows that the membrane 60 is lowered onto the surface of the substrate 100. The membrane 60 engages with the substrate 100 surface with adequate pressure, and the DFL material 40 is transferred from the compound surface 90 of the membrane 60 to the surface of the substrate 100 to produce a functional film pattern 110 with desired lubrication properties. The compressibility of the membrane 60 allows adequate pressure to be applied onto the substrate 100 without damage thereto. In one embodiment, the material 40 is transferred in a laminar and controlled manner to produce a film pattern 110 with a uniform thickness.

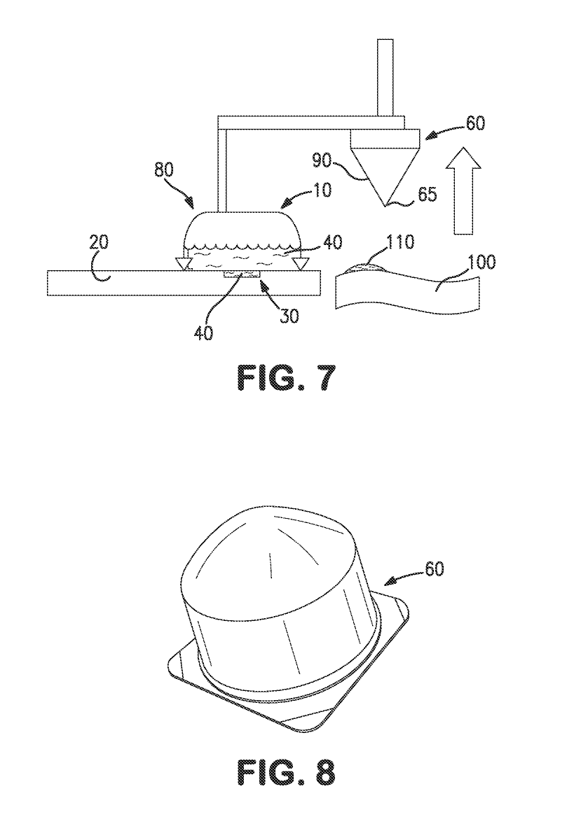

FIG. 7 shows that the membrane 60 is raised upwards and away from the substrate 100. Because the adhesion between substrate 100 and material 40 is greater than the adhesion between the membrane 60 and material 40, the selected compound surface 90 of the membrane 60 does not contain any residual material. In this manner, a functional film with a pre-defined pattern 110 is produced onto the substrate 100.

A second layer of DFL material 40 may be applied in a second cycle in accordance with the aforementioned steps described in FIGS. 1-7. The process may be repeated until the desired thickness of the film pattern 110 is achieved. Solvent and/or additional DFL material 40 may be intermittently added into the trough 30 if deemed necessary. Each subsequent layer is applied directly over the preceding layer with virtually no overlap of each of the layers. Each layer can be accurately placed on top of the preceding layer to ensure a well-defined pattern is built-up and produced. In this manner, the present invention offers improved repeatability for each DFL layer to be applied onto the substrate 100 with the same geometry, size, position and thickness, thereby allowing a film pattern 110 to be incrementally built-up and produced with precision controlled thickness and geometry previously not attainable with conventional techniques. Unlike conventional methods for applying DFL materials 40, the present invention allows the film pattern 110 to be built-up onto the substrate 100 at an incremental thickness of no more than 100 microns per each engagement of the membrane 60 with the substrate 100. Such control in creation of the desired film pattern 110 is not possible with manual or automated application of the DFL 40 by methods such as brushing, spraying, dipping and the like. By controlling various variables, including by way of example and not intended to be limiting, the amount of tacky DFL 40 formed as a result of solvent flashing via atmospheric exposure within the reservoir 10 per each cycle, and the pressure by which the membrane 60 engages with the trough 30 and thereafter the substrate 100, the present invention eliminates or substantially reduces the risk of applying excessive DFL material 40 beyond a prescribed upper limit.

Furthermore, the DFL material 40 is preferably pulled from the bottom of the DFL reservoir 10 to ensure that any solid settling would favorably increase the solids concentration in the DFL 40 contained within the trough 30 per each cycle. As a result, the present invention eliminates the need to periodically redisperse the sediment of the DFL material that can readily form on settling.

The reservoir 10, non-porous membrane 60 and GDP 20 can be interconnected by any suitable means such as mechanical linkage, integrated electromechanical motion or programmable positioning devices. Movement of the various components can be auto regulated by means of a control system as known in the art.

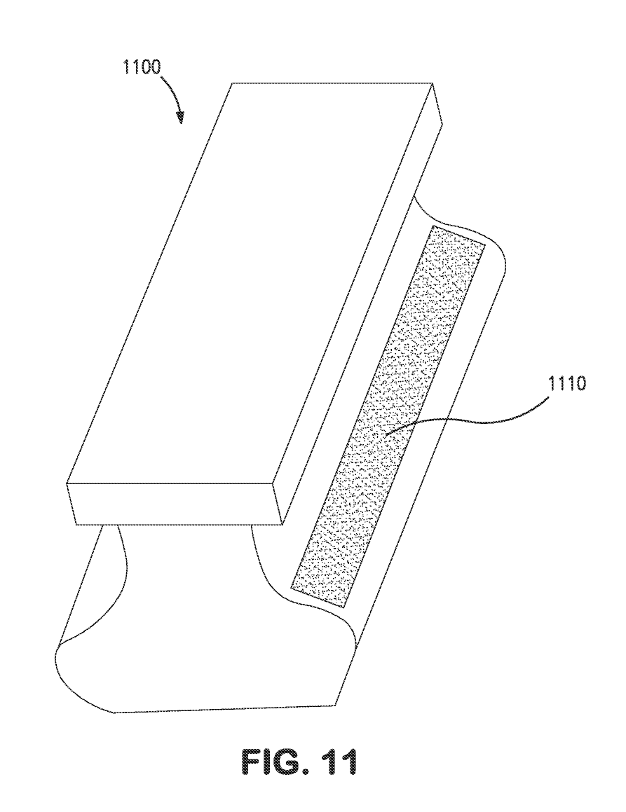

FIG. 11 shows an example of a part 1100 that can be applied with DFL material 40 to produce a pattern 1110 in accordance with the principles of the present invention. FIG. 11 shows a turbine blade root (i.e., dovetail) 1100 applied with a DFL 40 by the methods of the present invention to produce a well-defined rectangular film pattern 1110 having a final thickness that is incrementally built-up using one or more cycles. Advantageously and in contrast to conventional techniques, the improved precision and accuracy of the present invention eliminates the need to mask those regions of the turbine blade root 1100 surrounding the DFL material 40. The pattern 1110 can be created by the present invention without the risk of residual DFL material 40 contacting the regions of the part 1100 where no DFL material 40 is intended to be applied.

The ability to apply a customized film pattern 1110 having protective properties with a specific shape and thickness onto a part 1100 such as shown in FIG. 11 by the methods of the present invention is a significant advancement over manual and automated applications. A Dry Film Lubricant (DFL) or other material, such as a Coating Masking Agent (CMA), ceramic metallic thin film, ceramic-ceramic thin film or organometallic thin film would typically be applied to a part, such as that of FIG. 11, either manually with a brush or other suitable applicator or automatically with a spray device. Such conventional methods create inferior patterns because the area in which the material would be applied would be loosely defined by the inability of the operator or application device to apply material within a restricted region. Furthermore, the process benefits of material efficiency and safety have not been realized by the conventional methods because such methods must be regulated by some other framing material that subsequently needs to be removed.

The elimination of masking selected regions of the part translates into reduced amounts of material generated as waste. Not only are masking agents eliminated, but less DFL waste material is generated by the ability to build-up the pattern in an incremental thickness and confine the DFL material exclusively within the interior volume of the trough. Furthermore, the elimination of masking agents and the elimination of personnel needing to manually brush or spray hazardous solvent materials onto the part during each cycle reduces exposure to hazardous materials, thereby creating a safer environment.

It should be understood that any suitable material besides DFL's can be used with the present invention. Selection of a suitable material is based at least on ensuring that the properties of the resultant material are compatible with the operational environment to which the part is exposed. In one embodiment, any functional film can be applied directly onto a selected surface of the substrate, such as for example coating masking agents, ceramic metallic thin films, organometallic thin films or ceramic-ceramic thin films. Such films can find use in various industries, including aerospace and energy. The type of material that is selected to be applied onto a part may determine, at least in part, the type and design of non-porous membrane that is employed during the cycling to ensure that the material can be adequately transferred to and from the membrane.

The parts can be applied with any suitable material including those mentioned herein. In one embodiment, a compressor blade can be applied with a ceramic metallic thin functional film by the method of the present invention to produce a specific pattern at selected locations of the blade. It should be understood that the surfaces of the parts can have any shape such as, for example, flat, cylindrical, spherical, compound angles, textured or concave and/or convex surfaces. The ability of the present invention to transfer various materials which are tacky or non-tacky from a flat GDP surface to a compound surface without distortion and/or loss of the pattern of the resultant film is a significant improvement over conventional processes.

### Example 1

Tests were performed to apply a pre-defined pattern of DFL film onto a paper target substrate in accordance with the methods of the present invention. The DFL material was commercially available Molydag®, which is made and sold by Indestructible Paint located in Birmingham, United Kingdom. A geometry definition plate was constructed with the pre-defined pattern. The pre-defined pattern was rectangular shaped to test the transfer capabilities of Molydag® DFL from the GDP to the membrane and subsequently the transfer of Molydag® DFL from the membrane onto the paper target substrate.

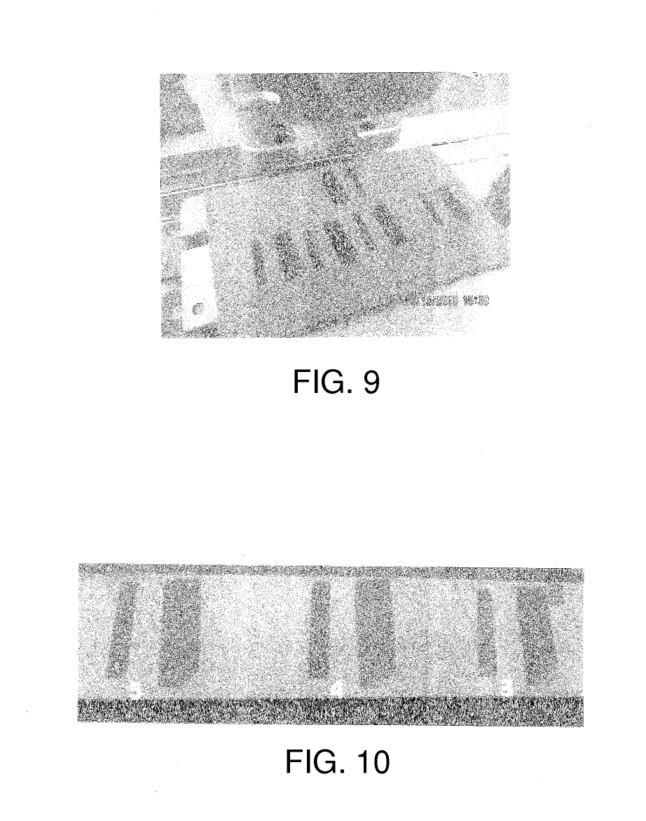

A silicon compressible membrane was selected for transferring the Molydag® DFL from the GDP to the paper target. The membrane is shown in FIG. 8. It was observed that the membrane successfully transferred all of the Molydag® DFL to the paper target by cycle number 5. The patterns are shown in FIG. 9. It was observed from the test results that 5 cycles ensure the rectangular patterns were adequately produced onto the paper target.

All of the patterns were well-defined. The Molydag® DFL was transferred consistently and accurately from the GDP to the silicone membrane and then to the paper target. The incremental thickness was built-up in a controller manner. During the cycles, the thickness was controlled by either the depth of the trough in the GDP or the number of applied layers or a combination of both.

### Example 2

Following the successful creation of the rectangular patterns on the paper target, the next sets of tests were performed on a metal plate substrate. The part surface was a rectangular-shaped bar of cold rolled steel that was prepared by lightly blasting the surface with 46 mesh aluminum oxide media. Molydag® was used as the DFL. The silicone membrane of FIG. 8 was employed in these tests. The same patterns as in Example 1 were produced.

It was observed that the membrane successfully transferred all of the Molydag® DFL to the metallic plate. It was observed from the test results that 5 cycles ensure the rectangular patterns were adequately produced onto the paper target. Based on the results of Example 1, the number of cycles employed to create the patterns was 3, 4 and 5, respectively.

The results are shown in FIG. 10. All of the patterns were well-defined. The Molydag® DFL was transferred consistently and accurately from the GDP to the silicone membrane and then to the paper target. The incremental thickness was built-up in a controller manner. During the cycles, the thickness was controlled by either the depth of the trough in the GDP or the number of applied layers or a combination of both.

While it has been shown and described what is considered to be certain embodiments of the invention, it will, of course, be understood that various modifications and changes in form or detail can readily be made without departing from the spirit and scope of the invention. It is, therefore, intended that this invention not be limited to the exact form and detail herein shown and described, nor to anything less than the whole of the invention herein disclosed and hereinafter claimed.

1. A method for producing a predefined pattern onto a substrate surface, comprising:
providing a non-porous membrane comprising a distal tip;
providing a plate having a trough, said trough filled with a selected material and inscribed with the predefined pattern therewithin;
lowering the non-porous membrane toward the plate at a location so as to avoid the distal tip from being immersed in the trough;
engaging a selected surface of the non-porous membrane with the material;
transferring said material from the reservoir onto the surface of the membrane, wherein said material adheres to the membrane in a manner that conforms to the predefined pattern contained within said trough;
engaging the selected surface of the non-porous membrane with the substrate;
transferring said material from the membrane to the substrate at a selected location along the substrate; and
lifting the membrane away from said substrate thereby producing the pattern on the substrate.

2. The method of claim 1, further comprising:
providing an enclosed material reservoir configured to move over a surface of the plate;
loading the material into the enclosed material reservoir;
positioning the enclosed material reservoir over the plate; and
transferring material from the reservoir into the trough of the plate.

3. The method of claim 1, further comprising the step of selecting the material to have properties compatible with an operational environment of the substrate.

4. The method of claim 1, further comprising moving the enclosed material reservoir away from the trough filled with material so as to expose the trough for the subsequent engagement with the non-porous membrane.

5. The method of claim 4, further comprising the step of wiping away any excess material along the plate.

6. The method of claim 1, wherein said pattern is built-up onto said substrate at an incremental thickness of no more than about 100 microns per each engagement of the membrane with the substrate.

7. The method of claim 3, wherein the material is selected from the group consisting of dry film lubricants, coating masking agents, ceramic metallic thin films, organometallic thin films, ceramic-ceramic thin films and combinations thereof.

8. The method of claim 1, wherein said selected surface is a compound surface.

9. A method for producing a predefined pattern onto a substrate surface, comprising:
providing a non-porous membrane comprising a distal tip;
providing a plate having a trough, said trough filled with a dry film lubricant (DFL) and further wherein said trough is inscribed with the predefined pattern therewithin;
lowering the non-porous membrane toward the plate at a location so as to avoid the distal tip from being immersed in the trough;
engaging a selected surface of the non-porous membrane with the DFL;
transferring said DFL from the reservoir onto the surface of the membrane, wherein said DFL adheres to the membrane in a manner that conforms to the predefined pattern contained within said trough;
engaging the selected surface of the non-porous membrane with the substrate;
transferring said DFL from the membrane to the substrate at a selected location along the substrate; and
lifting the membrane away from said substrate thereby producing the pattern on the substrate;
wherein said pattern is produced without masking any portion of the substrate.

10. The method of claim 9, further comprising transferring said DFL from a flat geometrical surface in said trough to a selected compound surface of the membrane.

11. The method of claim 9, wherein said pattern is built-up onto said substrate at an incremental thickness of no more than about 100 microns per each engagement of the membrane with the substrate.

12. The method of claim 9, wherein said DFL is applied onto a region of the substrate that is applied with a material selected from the group consisting of dry film lubricants, coating masking agents, ceramic metallic thin films, organometallic thin films, ceramic-ceramic thin films and combinations thereof.

13. The method of claim 9, further comprising:
providing an enclosed DFL reservoir configured to move over a surface of the plate;
loading the DFL into the enclosed DFL reservoir;
positioning the enclosed DFL reservoir over the plate; and
transferring DFL from the reservoir into the trough of the plate.

14. The method of claim 9, further comprising moving the enclosed DFL reservoir away from the trough filled with DFL so as to expose the trough for the subsequent engagement with the non-porous membrane.

15. The method of claim 14, further comprising the step of wiping away any excess DFL along the plate.

16. The method of claim 9, wherein said pattern is a functional film.

17. The method of claim 14, further comprising automating the method for producing the predefined pattern with a control system.

18. The method of claim 13, further comprising sealing the enclosed DFL reservoir.

19. A pre-defined pattern applied onto a substrate by the process of claim 9.

20. The pre-defined pattern of claim 19, wherein said substrate is a compressor blade.
